(19) United States
(12) Patent Application Publication
(10) Pub. No.: US 2025/0043547 A1
(43) Pub. Date: Feb. 6, 2025

(54) WORK MACHINE AND METHOD OF CONTROLLING WORK MACHINE

(71) Applicant: KOMATSU LTD., Tokyo (JP)

(72) Inventor: Kazumichi OKAJIMA, Tokyo (JP)

(21) Appl. No.: 18/720,163

(22) PCT Filed: Dec. 19, 2022
(86) PCT No.: PCT/JP2022/046708

§ 371 Date: Jun. 14, 2024

(30) Foreign Application Priority Data
Feb. 2, 2022 (JP) 2022-015069

(51) Int. Cl. E02F 9/26; E02F 9/20

(52) U.S. Cl. CPC E02F 9/265; E02F 9/2041

(57) ABSTRACT

A work machine includes a work machine main body, a detection section, and a posture control section. The work machine main body includes a traveling unit and a revolving unit including a work implement. The revolving unit is revolvable with respect to the traveling unit. The detection section detects a position of the work implement. The posture control section changes a posture of the work implement so as not to interfere with a virtual wall set at a predetermined position from the work machine main body when determining that the work implement interferes with the virtual wall based on the position of the work implement when the revolving unit is revolved.

### CROSS-REFERENCE TO RELATED APPLICATIONS

This application is a U.S. National stage application of International Application No. PCT/JP2022/046708, filed on Dec. 19, 2022. This U.S. National stage application claims priority under 35 U.S.C. § 119(a) to Japanese Patent Application No. 2022-015069, filed in Japan on Feb. 2, 2022, the entire contents of which are hereby incorporated herein by reference.

### BACKGROUND

### Field of the Invention

The present invention relates to a work machine and a method of controlling a work machine.

### Background Information

Excavators are often used for road construction, pipe burying work, etc. When using excavators on roads in urban areas, workers need to operate the excavators while paying attention to obstacles such as vehicles traveling on the side, fences, and guardrails.

Therefore, for example, International Publication No. 2019/189030 discloses setting a virtual wall to restrict the operation of an excavator machine. In International Publication No. 2019/189030, object detection sensors are disposed at the front, rear, left and right parts of the revolving unit, as well as in diagonal part, and obstacles around the excavator are detected and the virtual wall is set by measuring the distance from the excavator.

### SUMMARY

However, during the work, the operator has difficulty conforming the position of the virtual wall because it is difficult to see the monitor, etc., and the excavator operation is stopped due to interference with the virtual wall. When work is stopped in this manner, it is difficult to perform smooth work.

An object of the present disclosure is to provide a work machine and a method of controlling a work machine, whereby it is made possible to operate smoothly even when a virtual wall is set.

A work machine of the present disclosure includes a work machine main body, a detection section, and a posture control section. The work machine main body includes a traveling unit and a revolving unit. The revolving unit includes a work implement and is revolvable with respect to the traveling unit. The detection section detects a position of the work implement. When the posture control section determines, based on the position of the work implement, that the work implement interferes with a virtual wall set at a predetermined position from the work machine main body when the revolving unit is revolved, the posture control section changes the posture of the work implement so as not to interfere with the virtual wall.

A method of controlling a work machine of the present disclosure is a method of controlling the work machine including a traveling unit and a revolving unit having a work implement and being revolvable with respect to the traveling unit, the method includes a position detection step, a determination step, and an interference avoidance step. In the position detection step a position of the work implement is detected. In the determination step it is determined, based on a detection by the position detection step, whether or not the work implement interferes with a virtual wall set at a predetermined position from the work machine when the revolving unit is revolved. In the interference avoidance step, when it is determined that the work implement interferes with a virtual wall, the posture of the work implement is changed so as not to interfere with the virtual wall.

According to the present disclosure, it is possible to provide a work machine and a method of controlling a work machine, whereby it is made possible to operate smoothly even when a virtual wall is set.

### BRIEF DESCRIPTION OF DRAWINGS

FIG. 1 is a side view illustrating a hydraulic excavator according to the embodiment of the present disclosure.

FIG. 2 is a block diagram illustrating configurations of the hydraulic excavator and its control system according to the embodiment of the present disclosure.

FIG. 3 is a block diagram illustrating a configuration of a hydraulic circuit of the hydraulic excavator according to the embodiment of the present disclosure.

FIG. 4A is a side schematic diagram for explaining posture detection of the hydraulic excavator according to the embodiment of the present disclosure, and FIG. 4B is a plan view for explaining a revolving angle of the hydraulic excavator according to the embodiment of the present disclosure.

FIG. 5A is perspective view illustrating a calculation point in a work implement of the hydraulic excavator according to the embodiment of the present disclosure, and FIG. 5B is a side view of a bucket of the hydraulic excavator according to the embodiment of the present disclosure.

FIG. 6 is a plan view illustrating an example of a virtual wall setting for the hydraulic excavator according to the present disclosure.

FIG. 7 is a perspective view illustrating a state in which the work implement of the hydraulic excavator according to the embodiment of the present disclosure revolves toward the virtual wall.

FIG. 8 is a view illustrating a state in which the work implement of the hydraulic excavator according to the embodiment of the present disclosure approaches the virtual wall.

FIG. 9 is a flowchart illustrating an operation of controlling the hydraulic excavator according to the embodiment of the present disclosure.

### DETAILED DESCRIPTION OF EMBODIMENT(S)

A hydraulic excavator as an example of a work machine according to the present disclosure will be described below with reference to the drawings.

### (Configuration)

### (Outline of Hydraulic Excavator 1)

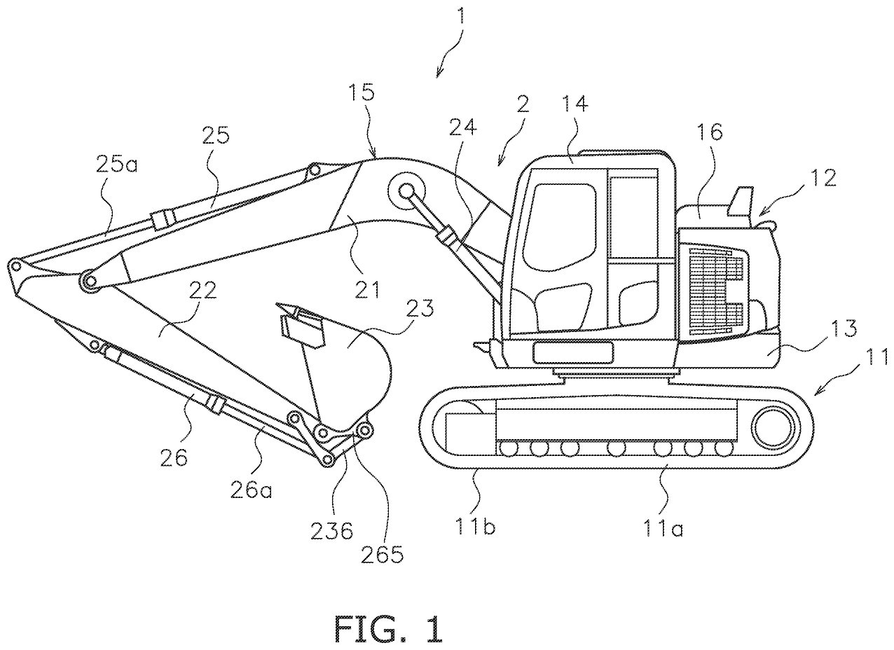

FIG. 1 is a side view illustrating a configuration of a hydraulic excavator 1 according to the present embodiment.

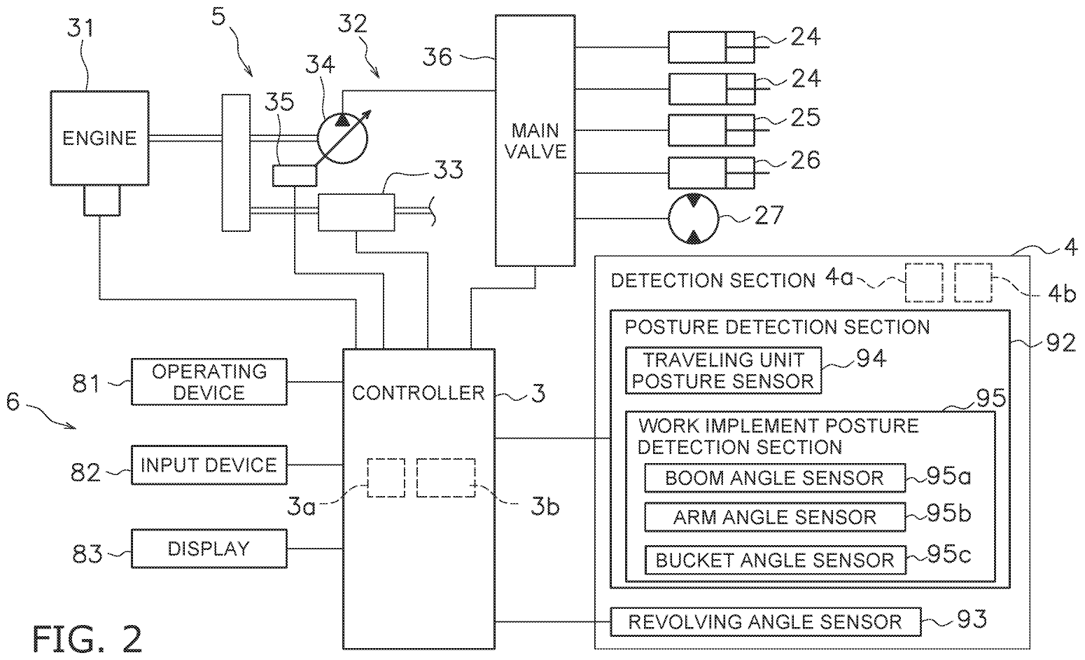

The hydraulic excavator 1 (an example of a work machine) includes an excavator main body 2 (an example of a work machine main body), a controller 3 (an example of a posture control section) (see FIG. 2), and a detection section 4 (see FIG. 2).

The excavator main body 2 includes a traveling unit 11 and a revolving unit 12. The traveling unit 11 includes a pair of traveling devices 11a. Each of the traveling devices 11a includes the crawler belts 11b. The hydraulic excavator 1 travels by rotating a traveling motor with the driving force from an engine and driving the crawler belts 11b.

The revolving unit 12 is disposed on the traveling unit 11. The revolving unit 12 is configured so as to be revolvable with respect to the traveling unit 11 around an axis extending in a vertical direction by a revolving motor 27 (see FIG. 2). A swing machinery is disposed on the revolving unit 12. A swing circle is disposed in the traveling unit 11 and meshes with an output pinion of the swing machinery. The rotational drive of the revolving motor 27 is decelerated by the swing machinery (not shown) and output from an output pinion. As a result, the swing machinery rotates inside or outside the swing circle, and the revolving unit 12 rotates with respect to the traveling unit 11.

The revolving unit 12 includes a revolving frame 13 (an example of a frame part), a cab 14, and a work implement 15. The revolving frame 13 is disposed above the traveling unit 11 and is a frame that is revolvable with respect to the traveling unit 11. The cab 14 is provided at the front left side of the revolving frame 13. The cab 14 is provided as a driver's seat where an operator sits during operation. Inside the cab 14, a driver's seat, an operating device 81 including a lever for operating the work implement 15, an input device 82, and various display devices (including a display 83 to be described later), and the like are disposed.

In this embodiment, unless otherwise specified, front, rear, left and right will be described with reference to the driver's seat inside the cab 14. A direction in which the driver's seat faces the front is defined as a front direction, and a direction opposite to the front direction is defined as a rear direction. A right side and a left side in a lateral direction when the driver's seat faces the front are defined as a right direction and a left direction, respectively.

The work implement 15 is attached to a front central position of the revolving unit 12. The work implement 15 includes a boom 21, an arm 22, and a bucket 23 (an example of an attachment), as shown in FIG. 1. A base end part of the boom 21 is rotatably connected to the revolving frame 13. Further, a distal end part of the boom 21 is rotatably connected to a base end part of the arm 22. A distal end part of the arm 22 is rotatably connected to the bucket 23. The bucket 23 is attached to the arm 22 so that its opening can face toward the revolving unit 12 (rear direction). The hydraulic excavator 1 including the bucket 23 attached in this manner is referred to as a backhoe.

Hydraulic cylinders 24 to 26 (a boom cylinder 24 (an example of a first cylinder), an arm cylinder 25 (an example of a second cylinder), and a bucket cylinder 26 (an example of a third cylinder) are disposed to correspond to the boom 21, the arm 22, and the bucket 23, respectively. The boom cylinders 24 are disposed on both the left and right sides of the boom 21. The work implement 15 is driven by driving these hydraulic cylinders 24 to 26. As a result, work such as excavation is performed.

An engine room 16 is disposed behind the cab 14 of the revolving unit 12. The engine room 16 houses an engine, a cooling unit for cooling the engine, a hydraulic pump, and the like.

### (Control Configuration of Hydraulic Excavator 1)

FIG. 2 is a block diagram illustrating configurations of the hydraulic excavator 1 and its control system. The hydraulic excavator 1 includes the controller 3, the detection section 4, a drive system 5, and an operation system 6.

### (Drive System 5)

The drive system 5 includes an engine 31, a hydraulic circuit 32, and a power transmission device 33. The engine 31 is controlled by a command signal from controller 3. The hydraulic circuit 32 supplies hydraulic fluid to the left and right boom cylinders 24, the arm cylinder 25, the bucket cylinder 26, and the revolving motor 27. The hydraulic circuit 32 includes a hydraulic pump 34, a pump control device 35, and a main valve 36. The hydraulic pump 34 is driven by the engine 31 and discharges hydraulic fluid. Hydraulic fluid discharged from the hydraulic pump 34 is supplied to the left and right boom cylinders 24, the arm cylinder 25, the bucket cylinder 26, and the revolving motor 27. The revolving motor 27 described above is, for example, a hydraulic motor. The revolving motor 27 is driven by hydraulic fluid from hydraulic pump 34. The revolving motor 27 revolves the revolving unit 12.

### (Hydraulic Circuit 32)

The hydraulic pump 34 is a variable displacement pump. The pump control device 35 is connected to the hydraulic pump 34. The pump control device 35 controls the tilt angle of hydraulic pump 34. The pump control device 35 includes, for example, a solenoid valve and is controlled by a command signal from the controller 3. The controller 3 controls the capacity of hydraulic pump 34 by controlling the pump control device 35. Although one hydraulic pump is shown in FIG. 2, a plurality of hydraulic pumps may be provided.

The main valve 36 controls the flow rate of hydraulic fluid supplied from the hydraulic pump 34 to the hydraulic cylinders 24 to 26 and the revolving motor 27. The hydraulic cylinders 24 to 26 and the revolving motor 27 are connected to hydraulic pump 34 by a hydraulic circuit via the main valve 36. The main valve 36 is controlled by a command signal from the controller 3. The controller 3 controls the operation of the work implement 15 by controlling the main valve 36. The controller 3 controls the revolution of the revolving unit 12 by controlling the main valve 36.

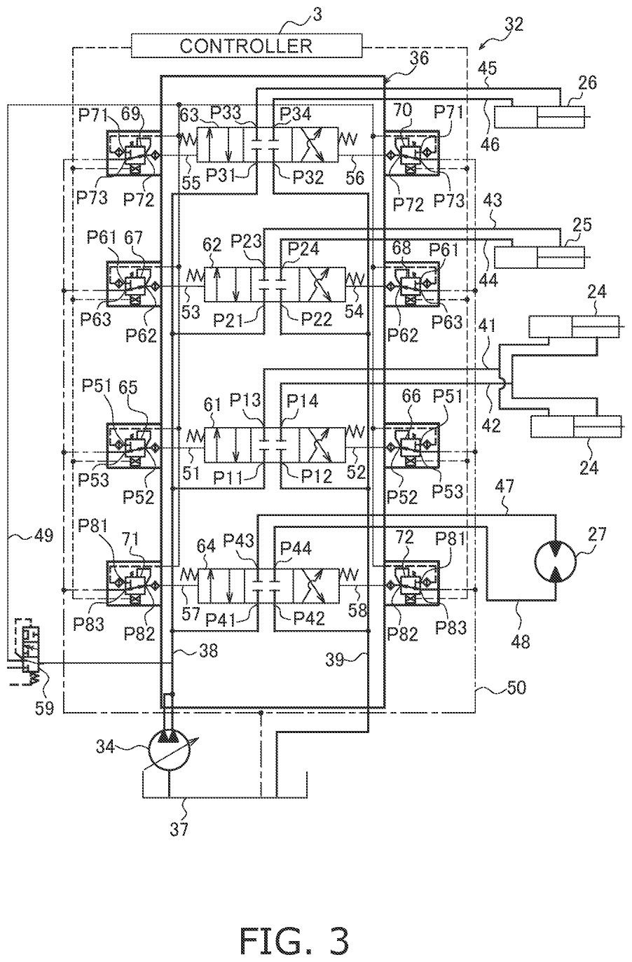

FIG. 3 is a hydraulic circuit diagram illustrating the hydraulic circuit 32. The hydraulic circuit 32 includes the main valve 36, a hydraulic fluid tank 37, a hydraulic fluid supply line 38, a hydraulic fluid return line 39, hydraulic fluid lines 41 to 48, a pilot oil supply line 49, a pilot oil return line 50, and pilot oil lines 51 to 58. In FIG. 3, the hydraulic fluid supply line 38, the hydraulic fluid return line 39, and the hydraulic fluid lines 41 to 48 are shown in thick solid lines, the pilot oil supply line 49 is shown in thin solid lines, and the pilot oil return line 50 is shown in single-dotted lines. The electrical connection from the controller 3 is indicated by a dotted line.

The hydraulic fluid tank 37 stores hydraulic fluid. The hydraulic fluid supply line 38 supplies hydraulic fluid from the hydraulic fluid tank 37 to the main valve 36. The hydraulic fluid return line 39 returns hydraulic fluid from the main valve 36 to the hydraulic fluid tank 37.

The main valve 36 includes a valve 61 for the boom, a valve 62 for the arm, a valve 63 for the bucket, and a valve 64 for the revolution.

Each of the valve 61 for the boom, the valve 62 for the arm, the valve 63 for the bucket, and the valve 64 for the revolution is a directional valve that contains four ports and can take three positions. Position of each of the valve 61 for the boom, the valve 62 for the arm, the valve 63 for the bucket, and the valve 64 for the revolution is switched by pilot oil pressure.

The valve 61 for boom includes four ports P11, P12, P13, and P14. The valve 61 for the boom includes a valve body, which is movable to a boom up position, a boom down position, and a stop position. The port P11 is connected to the hydraulic fluid supply line 38. The port P12 is connected to the hydraulic fluid return line 39. The port P13 is connected to bottom side cylinder chambers of the left and right boom cylinders 24 by hydraulic fluid line 41. The port P14 is connected to rod side cylinder chambers of the left and right boom cylinders 24 by hydraulic fluid line 42.

When the valve body of the valve 61 for the boom moves to the boom up position (left side in the figure), hydraulic fluid is supplied to the bottom side cylinder chambers of the boom cylinders 24, and hydraulic fluid is discharged from the rod side cylinder chambers. This extends the boom cylinders 24, causing the boom 21 to swing upward. When the valve body of the valve 61 for the boom moves to the boom down position (right side in the figure), hydraulic fluid is discharged from the bottom side cylinder chambers of the boom cylinders 24 and hydraulic fluid is supplied to the rod side cylinder chambers. This causes the boom cylinders 24 to contract and the boom 21 to swing downward. When the valve body of the valve 61 for the boom moves to the stop position (center in the figure), the supply and discharge of hydraulic fluid from each port stops, and the boom 21 is in a stop state.

The valve 62 for the arm includes four ports P21, P22, P23, and P24. The valve 62 for the arm includes a valve body which is movable to an arm up position, an arm down position, and a stop position. The port P21 is connected to hydraulic fluid supply line 38. The port P22 is connected to hydraulic fluid return line 39. The port P23 is connected to a rod side cylinder chamber of the arm cylinder 25 by the hydraulic fluid path 43. The port P24 is connected to a bottom side cylinder chamber of the arm cylinder 25 by hydraulic fluid channel 44.

When the valve body of the valve 62 for the arm moves to the arm up position (left side in the figure), hydraulic fluid is supplied to the rod side cylinder chamber of arm cylinder 25, and hydraulic fluid is discharged from the bottom side cylinder chamber. This causes the arm cylinder 25 to contract, causing the arm 22 to swing outward with respect to the boom 21. When the valve body of the valve 62 for the arm moves to the arm down position (right side in the figure), hydraulic fluid is discharged from the rod side cylinder chamber of the arm cylinder 25 and hydraulic fluid is supplied to the bottom side cylinder chamber. This extends the arm cylinder 25, causing the arm 22 to swing inward with respect to the boom 21. When the valve body of the valve 62 for the arm moves to the stop position (center in the figure), the supply and discharge of hydraulic fluid from each port stops, and the arm 22 is in a stopped state.

The valve 63 for the bucket includes four ports P31, P32, P33, and P34. The valve 63 for the bucket includes a valve body, which is movable to a bucket up position, a bucket down position, and a stop position. The port P31 is connected to the hydraulic fluid supply line 38. The port P32 is connected to the hydraulic fluid return line 39. The port P33 is connected to a rod side cylinder chamber of the bucket cylinder 26 by the hydraulic fluid line 45. The port P34 is connected to a bottom side cylinder chamber of the bucket cylinder 26 by hydraulic fluid line 46.

When the valve body of the valve 63 for the bucket moves to the bucket up position (left side in the figure), hydraulic fluid is supplied to the rod side cylinder chamber of the bucket cylinder 26, and hydraulic fluid is discharged from the bottom side cylinder chamber. This causes the bucket cylinder 26 to contract and the bucket 23 to swing outward with respect to the arm 22. When the valve body of the valve 63 for the bucket moves to the bucket down position (right side in the figure), hydraulic fluid is discharged from the rod side cylinder chamber of the bucket cylinder 26 and hydraulic fluid is supplied to the bottom side cylinder chamber. This causes bucket cylinder 26 to extend and bucket 23 to swing inward with respect to the arm 22 (also referred to as in the rolling-in direction). When the valve body of the valve 63 for the bucket moves to the stop position (center in the figure), the supply and discharge of hydraulic fluid from each port stops, and the bucket 23 is in a stopped state.

The valve 64 for the revolution includes four ports P41, P42, P43, and P44. The valve 64 for the revolution includes a valve body, which is movable to a left revolving position, a right revolving position, and a stop position. The port P41 is connected to the hydraulic fluid supply line 38. The port P42 is connected to the hydraulic fluid return line 39. The port P43 is connected to the revolving motor 27 by the hydraulic fluid line 47. The port P44 is connected to the revolving motor 27 by the hydraulic fluid line 48.

When the valve body of the valve 64 for the revolution moves to the left revolving position (left side in the figure), the revolving motor 27 is driven and the revolving unit 12 revolves left with respect to the traveling unit 11. When the valve body of the valve 64 for the revolution moves to the right revolving position (right side in the figure), the revolving motor 27 is driven and the revolving unit 12 revolves right with respect to the traveling unit 11. When the valve body of the valve 64 for the revolution moves to the stop position (center in the figure), the supply and discharge of hydraulic fluid from each port stops, and the revolving unit 12 is in a stop state.

The main valve 36 includes a boom up EPC (Electric Proportional Control) valve 65, a boom down EPC valve 66, an arm up EPC valve 67, an arm down EPC valve 68, a bucket up EPC valve 69, a bucket down EPC valve 70, a left revolving EPC valve 71, a right revolving EPC valve 72. Each of these EPC valves 65 to 72 is used as a pilot valve, supplying pilot oil to the valve 61 for the boom, the valve 62 for the arm, the valve 63 for the bucket, or the valve 64 for the revolution to change the valve position. Each of the EPC valves 65 to 72 is connected to the controller 3 and opens and closes based on a command signal from the controller 3.

The pilot oil supply line 49 branches from hydraulic fluid supply line 38. The pilot oil supply line 49 supplies pilot oil to EPC valves 65 to 72. A pressure reducing valve 59 is provided in the pilot oil supply line 49. Hydraulic fluid discharged from the hydraulic fluid tank 37 by the hydraulic pump 34 is reduced by the pressure reducing valve 59 and supplied to each of the EPC valves 65 to 72. The pilot oil return line 50 returns pilot oil from each of the EPC valves 65 to 72 to the hydraulic fluid tank 37.

The boom up EPC valve 65 and the boom down EPC valve 66 supply pilot oil to the pilot chambers of the valve 61 for the boom to switch the position of the valve body of the valve 61 for the boom. Each of the boom up EPC valve 65 and the boom down EPC valve 66 includes three ports P51, P52, and P53. The port P51 of the boom up EPC valve 65 and the port P51 of the boom down EPC valve 66 are connected to the pilot oil supply line 49. The port P53 of the boom up EPC valve 65 and the port P53 of the boom down EPC valve 66 are connected to the pilot oil return line 50. The port P52 of the boom up EPC valve 65 is connected to the pilot oil chamber of the valve 61 for the boom via pilot oil line 51. The port P52 of the boom down EPC valve 66 is connected to the pilot oil chamber of the valve 61 for the boom via the pilot oil line 52.

When the connection between the port P53 and the port P52 is gradually switched to the connection between the port P51 and the port P52, the valve gradually opens, and the boom up EPC valve 65 and the boom down EPC valve 66 supply pilot oil to the valve 61 for the boom.

For example, when the opening degree of the boom up EPC valve 65 is set to be larger than the opening degree of the boom down EPC valve 66 in response to a command signal from the controller 3 while the hydraulic pump 34 is in operation, the valve body of the valve 61 for the boom moves to the up position. This causes the boom cylinder 24 to extend and the boom 21 to swing upward.

The arm up EPC valve 67 and the arm down EPC valve 68 supply pilot oil to the pilot chambers of the valve 62 for the arm to switch the position of the valve body of valve 62 for the arm. Each of the arm up EPC valve 67 and the arm down EPC valve 68 includes three ports P61, P62, and P63. The port P61 of the arm up EPC valve 67 and the port P61 of the arm down EPC valve 68 are connected to the pilot oil supply line 49. The port P63 of the arm up EPC valve 67 and the port P63 of the arm down EPC valve 68 are connected to the pilot oil return line 50. The port P62 of the arm up EPC valve 67 is connected to the pilot oil chamber of the valve 62 for the arm via pilot oil line 53. The port P62 of the arm down EPC valve 68 is connected to the pilot oil chamber of the valve 62 for the arm via pilot oil line 54.

When the connection between the port P63 and the port P62 is gradually switched to the connection between the port P61 and the port P62, the valve gradually opens, and the arm up EPC valve 67 and the arm down EPC valve 68 supply pilot oil to the valve 62 for the arm.

For example, when the opening degree of the arm up EPC valve 67 is set to be larger than the opening degree of the arm down EPC valve 68 in response to a command signal from the controller 3 while the hydraulic pump 34 is in operation, the valve body of the valve 62 for the arm moves to the up position. This causes the arm cylinder 25 to contract and the arm 22 to swing upward.

The bucket up EPC valve 69 and the bucket down EPC valve 70 supply pilot oil to the pilot chambers of the valve 63 for the bucket to switch the position of the valve body of the valve 63 for the bucket. Each of the bucket up EPC valve 69 and the bucket down EPC valve 70 includes three ports P71, P72, and P73. The port P71 of the bucket up EPC valve 69 and the port P71 of the bucket down EPC valve 70 are connected to pilot oil supply line 49. The port P73 of the bucket up EPC valve 69 and the port P73 of the bucket down EPC valve 70 are connected to the pilot oil return line 50. The port P72 of the bucket up EPC valve 69 is connected to the pilot oil chamber of the valve 63 for the bucket via the pilot oil line 55. The port P72 of the bucket down EPC valve 70 is connected to the pilot oil chamber of the valve 63 for the bucket via the pilot oil line 56.

When the connection between the port P73 and the port P72 is gradually switched to the connection between the port P71 and the port P72, the valve gradually opens, and the bucket up EPC valve 69 and the bucket down EPC valve 70 supply pilot oil to the valve 63 for the bucket.

For example, when the opening degree of the bucket up EPC valve 69 is set to be larger than the opening degree of the bucket down EPC valve 70 in response to a command signal from the controller 3 while the hydraulic pump 34 is in operation, the valve body of the valve 63 for the bucket moves to the up position. This causes the bucket cylinder 26 to contract and the bucket 23 to swing in an outward direction with respect to the arm 22.

The left revolving EPC valve 71 and the right revolving EPC valve 72 supply pilot oil to the pilot chambers of the valve 64 for the revolution to switch the position of the valve body of the valve 64 for the revolution. Each of the left revolving EPC valve 71 and the right revolving EPC valve 72 includes three ports P81, P82, and P83. The port P81 of the left revolving EPC valve 71 and the port P81 of the right revolving EPC valve 72 are connected to the pilot oil supply line 49. The port P83 of the left revolving EPC valve 71 and the port P83 of the right revolving EPC valve 72 are connected to the pilot oil return line 50. The port P82 of the left revolving EPC valve 71 is connected to the pilot oil chamber of the valve 64 for the revolution via the pilot oil line 57. The port P82 of the right revolving EPC valve 72 is connected to the pilot oil chamber of the valve 64 for the revolution via the pilot oil path 58.

When the connection between the port P83 and the port P82 is gradually switched to the connection between the port P81 and the port P82, the valve gradually opens, and the left revolving EPC valve 71 and the right revolving EPC valve 72 supply pilot oil to the valve 64 for the revolution.

For example, when the opening degree of the left revolving EPC valve 71 is set to be larger than the opening degree of the right revolving EPC valve 72 in response to a command signal from the controller 3 while the hydraulic pump 34 is in operation, the valve body of the valve 64 for the revolution moves to the left revolving position. This causes the revolving motor 27 to drive and the revolving unit 12 to revolve left with respect to the traveling unit 11.

### (Power Transmission Device 33)

The power transmission device 33, shown in FIG. 2, transmits the driving force of the engine 31 to the traveling unit 11. The crawler belts 11b is driven by the driving force from the power transmission device 33 to drive the hydraulic excavator 1. The power transmission device 33 may be, for example, a torque converter or a transmission with multiple shifting gears. Alternatively, the power transmission device 33 may be another type of transmission such as HST (Hydro Static Transmission) or HMT (Hydraulic Mechanical Transmission).

### (Detection Section 4)

The detection section 4 shown in FIG. 2 detects a position of the work implement 15. The position of the work implement 15 includes a posture of the work implement 15. The detection section 4 includes a processor 4a, such as a CPU. The processor 4a executes processing for detecting the position of the work implement 15. The detection section 4 includes a storage device 4b. The storage device 4b includes memory such as RAM or ROM, and auxiliary storage devices such as HDD (Hard Disk Drive) or SSD (Solid State Drive). The storage device 4b stores data and programs for detecting the position of the work implement 15.

The detection section 4 includes a posture detection section 92 and a revolving angle sensor 93. The posture detection section 92 detects information for determining the posture of the hydraulic excavator 1.

The posture detection section 92 detects information for determining a posture of the traveling unit 11 and a posture of the work implement 15. The posture detection section 92 includes a traveling unit posture sensor 94 and a work implement posture detection section 95.

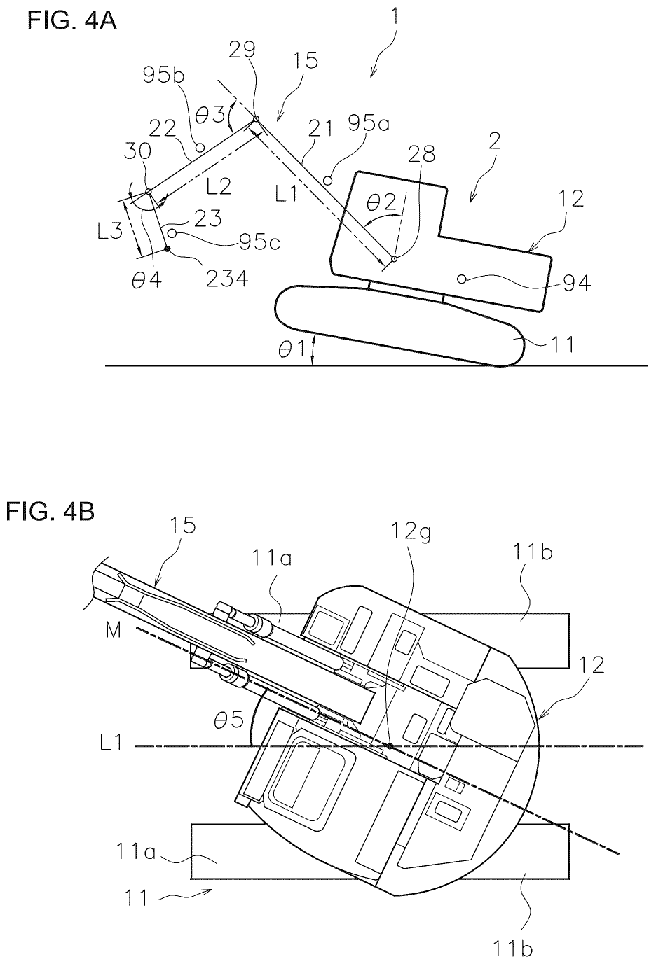

The traveling unit posture sensor 94 detects information for determining the posture of the traveling unit 11. The posture of the traveling unit 11 includes a pitch angle θ1 of the traveling unit 11. The traveling unit posture sensor 94 detects a first position data including the pitch angle θ1. As shown in FIG. 4A, the pitch angle θ1 of the traveling unit 11 is an inclination angle of the traveling unit 11 in the front-back direction relative to the horizontal direction. The traveling unit posture sensor 94 is, for example, an IMU (Inertial Measurement Unit). The traveling unit posture sensor 94 detects the first position data indicating the posture of the traveling unit 11.

The work implement posture detection section 95 detects information for determining the posture of the work implement 15. The posture of the work implement 15 includes a boom angle θ2, an arm angle θ3, and a bucket angle θ4. The work implement posture detection section 95 detects a second position data indicating the boom angle θ2, the arm angle θ3, and the bucket angle θ4.

The work implement posture detection section 95 includes a boom angle sensor 95a, an arm angle sensor 95b, and a bucket angle sensor 95c. The boom angle sensor 95a detects the boom angle θ2. The boom angle sensor 95a is, for example, an IMU. The boom angle θ2 is an angle of the boom 21 relative to the vertical direction of the traveling unit 11. The arm angle sensor 95b detects the arm angle θ3. The arm angle θ3 is an angle of the arm 22 relative to the boom 21. The arm angle sensor 95b is, for example, an IMU. The bucket angle sensor 95c detects the bucket angle θ4. The bucket angle θ4 is an angle of the bucket 23 relative to the arm 22. The bucket angle sensor 95c detects, for example, a stroke length of the bucket cylinder 26. The bucket angle θ4 is detected from the stroke length of the bucket cylinder 26. The work implement posture detection section 95 detects the second position data indicating the posture of the work implement 15.

The revolving angle sensor 93 detects a revolving angle θ5 of the revolving unit 12 relative to the traveling unit 11. The revolving angle sensor 93 detects revolving angle data indicating the revolving angle θ5. FIG. 4B is a view for explaining the revolving angle θ5. As shown in FIG. 4B, a straight line extending along the crawler belts 11b of the traveling unit 11 and passing through the revolving center 12g of the revolving unit 12 is defined as a first reference line L1. A straight line along the front-back direction of the revolving unit 12 through the revolving center 12g is defined as a revolving line M. The revolving angle θ5 is an angle formed by the first reference line L1 and the revolving line M. The revolving angle sensor 93 is, for example, an encoder disposed on the revolving motor 27 or a sensor that detects the teeth of the swing machinery. The revolving angle sensor 93 detects a third position data indicating a revolving position of the work implement 15.

The detection section 4 calculates a current position of the work implement 15 based on the first position data, the second position data, and the third position data.

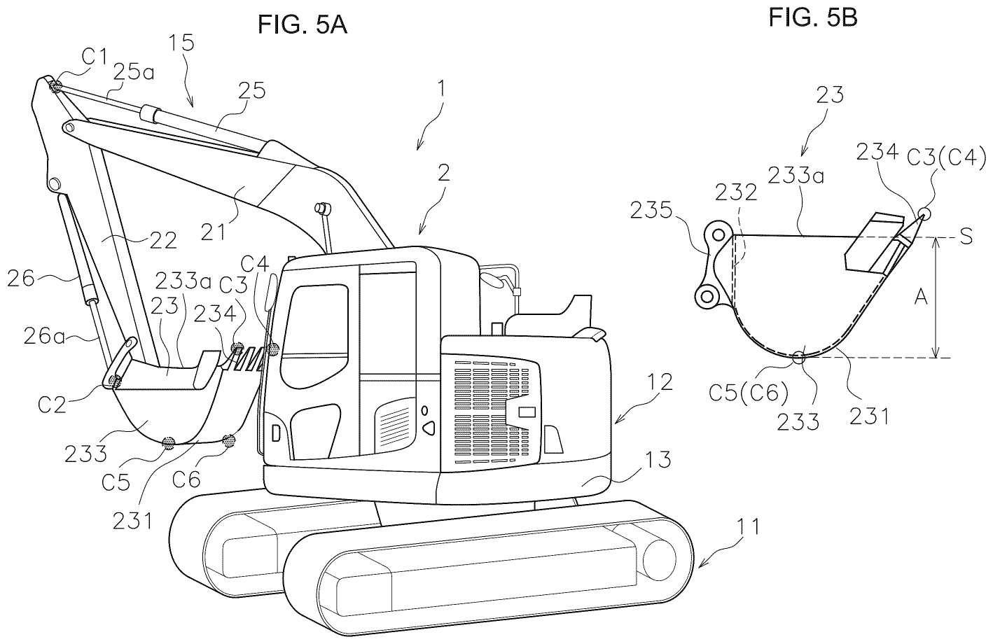

Here, the detection section 4 calculates the positions of predetermined calculation points of the work implement 15, because calculating all positions of the work implement 15 would increase the amount of calculations. FIG. 5A is a perspective view of the hydraulic excavator 1 to illustrate the predetermined calculation points of the work implement 15. For example, calculation points C1 to C6, whose positions are calculated by the detection section 4, are set on the work implement 15. The calculation points C1 to C6 are set at the portion of the work implement 15 that is most likely to be located at the outermost position from the revolving center 12g.

The calculation point C1 is set at the connection portion in a tip of a rod 25a of the arm cylinder 25 to the arm 22. The calculation point C2 is set at the connection point in a tip of a rod 26a of the bucket cylinder 26 to a link member 236. The link member 236 is connected between the bucket 23 and the tip of the rod 26a so as to be pivotable relative to the bucket 23 and the tip of the rod 26a, as shown in FIG. 1.

The calculation points C3 to C5 are set in the bucket 23. FIG. 5B is a side view of the bucket 23. As shown in FIG. 5B, the bucket 23 includes a bottom part 231, a back part 232, a pair of side wall parts 233, a tooth 234, and a bracket 235. The bottom part 231 has a curved shape. The back part 232 is connected to the bottom part 231. A pair of side wall parts 233 cover the sides of the space enclosed by the bottom part 231 and the back part 232. The tooth 234 is disposed at the tip of the bottom part 231 (an end opposite to the back part 232). The bracket 235 is disposed in the rear part 232. The tip of the arm 22 is rotatably attached to the bracket 235. The link member 236 (see FIG. 1) rotatably connected to the tip of the rod 26a of the bucket cylinder 26 is attached to the bracket 235.

The calculation point C3 is set at the left end in the width direction of the tooth 234. The calculation point C4 is set at the right end in the width direction of tooth 234. The end of the sidewall part 233 that forms an edge of an opening of the bucket 23 (the top end of the sidewall part 233 in FIG. 5B) is designated as 233a. The plane including the ends 233a of the pair of sidewall parts 233 is defined as a bucket excavation surface S. The calculation point C5 is set at the left end in the width direction of the portion of the bottom part 231 where the distance A from the bucket excavation surface S is the largest. The calculation point C6 is set at the right end in the width direction of the portion of the bottom part 231 where the distance A from the bucket excavation surface S is the largest. In FIG. 5B, the calculation point C3 and the calculation point C4 overlap, and the calculation point C5 and the calculation point C6 overlap.

The detection section 4 calculates the three-dimensional positions of the calculation points C1 to C6 of the work implement 15 from the first position data, the second position data, and the third position data.

The storage device 4b stores dimensional data of the work implement 15. The dimensional data is shape data such as length, thickness, and width of the boom 21, the arm 22, and the bucket 23. For example, the dimensional data includes the length L1 of the boom 21, the length L2 of the arm 22, and the length L3 of the bucket 23, as shown in FIG. 4(a). Specially the length L1 of the boom 21 is the distance between a boom pin 28, which connects the boom 21 to the revolving unit 12, and an arm pin 29, which connects the arm 22 to the boom 21. The length L2 of the arm 22 is the distance between the arm pin 29 and a bucket pin 30, which connects the bucket 23 to the arm 22. The length of the bucket 23 is the distance between the bucket pin 30 and the tip of the tooth 234 of the bucket 23.

When the controller 3 receives a signal of the revolving operation instruction, the detection section 4 calculates the positions of the calculation points C1 to C6 of the work implement 15 based on the dimensional data stored in the storage device 4b, the pitch angle θ1, the boom angle θ2, the arm angle θ3, and the bucket angle θ4. The detection section 4 transmits calculated position data of the calculation points C1 to C6 to controller 3.

### (Operation System 6)

As shown in FIG. 2, the operation system 6 includes an operating device 81 (an example of an operation instruction section), an input device 82 (an example of a selection section), and a display 83. The operating device 81 is operable by an operator. The operating device 81 includes, for example, levers, pedals, or switches. The operating device 81 outputs an instruction signal to the controller 3 according to an operation by the operator. The controller 3 controls the main valve 36 to operate the work implement 15 in accordance with the operation of the operating device 81 by the operator. The controller 3 controls the main valve 36 to revolve the revolving unit 12 in accordance with the operation of the operating device 81 by the operator. The controller 3 controls the engine 31 and the power transmission device 33 so that the hydraulic excavator 1 travels in accordance with the operation of the operating device 81 by the operator.

The input device 82 is operable by the operator. The input device 82 is, for example, a touch screen. However, the input device 82 may include hardware keys. The display 83 is, for example, an LCD, OELD, or other type of display. The display 83 displays a screen in accordance with a display signal from the controller 3.

The operator enters various settings related to the hydraulic excavator 1 by operating the input device 82. The input device 82 outputs input signals in accordance with operations by operator.

The operator can set a virtual wall W by operating the input device 82. The virtual wall W is a wall set up virtually by the controller 3 to prevent the work implement 15 from entering during the work. For example, the virtual wall W is set on the hydraulic excavator 1 side of an area that prevents entry. The setting of the virtual wall W may be done manually by the operator or automatically.

For example, when the hydraulic excavator 1 is equipped with an imaging section that captures images of the surrounding area and the images captured by the imaging section are displayed on the display 83, the operator can check the surrounding situation on the display 83 and manually set the virtual wall W in front of the obstacle (on the hydraulic excavator 1 side). When the operator determines a position where the virtual wall W is set on the display 83 with the input device 82 (for example, touch screen), the controller 3 converts the position on the display 83 to the actual position and sets the virtual wall W.

When the hydraulic excavator 1 is equipped with a sensor to detect obstacles, the controller 3 can automatically set a virtual wall W in front of the obstacle when an obstacle is detected by the sensor.

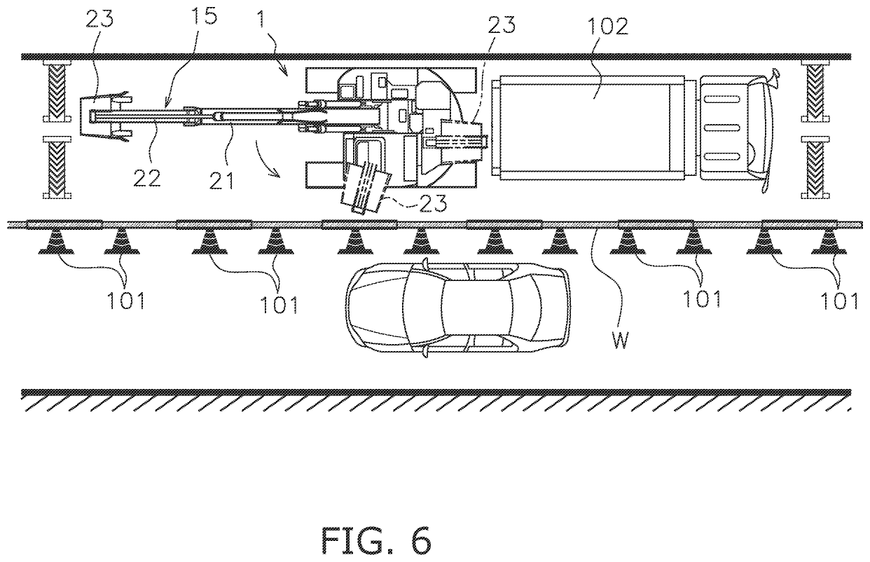

FIG. 6 is a view illustrating an example of setting a virtual wall W. FIG. 6 FIG. 6 is a plan view illustrating a construction site. FIG. 6 illustrates the construction site where a road is divided by a plurality of road cones 101. FIG. 6 illustrates a state in which one lane in two lane road is closed for construction work. A plurality of road cones 101 are arranged along the center lane. Vehicles are passing on one side of the road cone 101, and construction is being carried out on the other side. In FIG. 6, a dump truck 102 is shown, and after excavating earth and sand, the hydraulic excavator 1 revolves to load the earth and sand onto the dump truck 10. In such cases, for example, the virtual wall W can be set up along several road cones 101. The bucket 23 that has revolved to approach the virtual wall W and the bucket 23 that has revolved to a position facing the dump truck 102, are shown in two-dot chain lines.

The input device 82 also functions as a selection section to select whether or not to execute interference avoidance control (described below) to avoid interference so that the work implement 15 does not interfere with the virtual wall W when revolving. In other words, whether or not to execute interference avoidance control can be selected by operator inputting with the input device 82.

### (Controller 3)

As shown in FIG. 2, the controller 3 includes a processor 3a, such as a CPU. The processor 3a executes processing for control of the hydraulic excavator 1. The controller 3 includes a storage device 3b. The storage device 3b includes memory such as RAM or ROM, and auxiliary storage devices such as HDD (Hard Disk Drive) or SSD (Solid State Drive). The storage device 3b stores data and programs for controlling the hydraulic excavator 1.

The controller 3 receives the operation instruction signal from the operating device 81. The controller 3 receives the input signal from the input device 82. The controller 3 outputs a display signal to the display 83. The controller 3 receives the position data of calculation points C1 to C6 from the detection section 4.

When the controller 3 receives the input signal for setting the virtual wall W input by the operator on input device 82, the controller 3 converts the position set on display 83 by the operator to the actual position and sets the virtual wall W.

The controller 3 receives an input signal for selecting whether or not to execute the interference avoidance control, which is input by the operator with input device 82.

When the operator operates the operating device 81 to execute an operation instruction (also called a revolving instruction) for revolving the revolving unit 12 in a state in which the virtual wall W is set, the controller 3 determines whether the work implement 15 interferes with the virtual wall W based on the position data of the calculation points C1 to C6 received from the detection section 4. When the controller 3 determines that the work implement 15 interferes with the virtual wall W, the controller 3 executes the interference avoidance control to change the posture of the work implement 15.

The controller 3 determines whether the calculation points C1 to C6 of the work implement 15 interfere with the virtual wall W when the revolving unit 12 is revolved in accordance with the operation instruction.

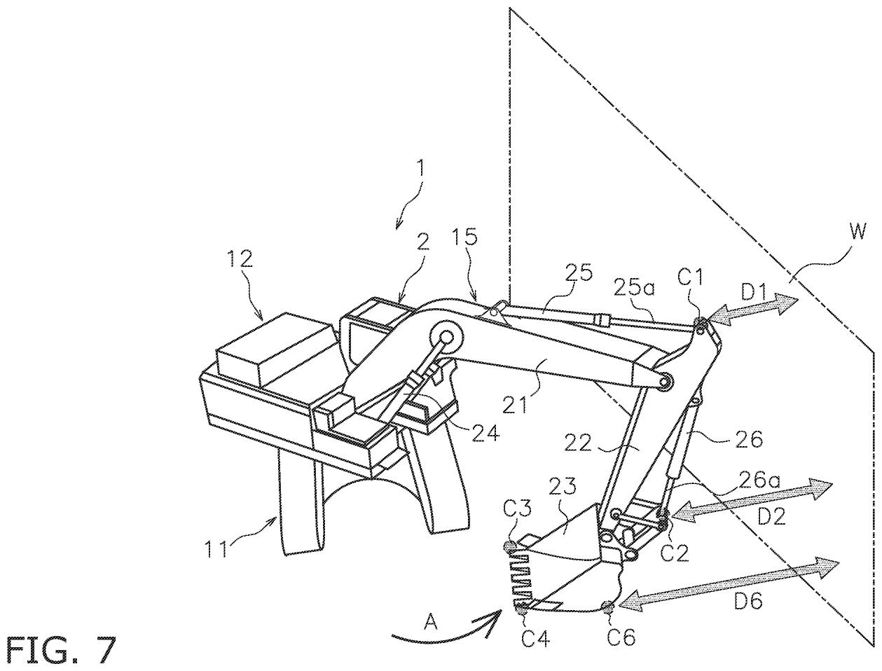

FIG. 7 is a perspective view illustrating a state in which the hydraulic excavator 1 revolves in the direction of arrow A toward the virtual wall W. When the revolving operation instruction is input, the controller 3 calculates the distance from each of calculation points C1 to C6 to the virtual wall W, and determines whether or not each of calculation points C1 to C6 intersects the virtual wall W when revolving the work implement 15 with the current posture, from the current position of calculation points C1 to C6. When any one of the calculation points C1 to C6 intersect with the virtual wall W, the controller 3 determines that the work implement 15 interferes with the virtual wall W. When none of the calculation points C1 to C6 of the work implement 15 intersect the virtual wall W, the controller 3 determines that the work implement 15 does not interfere with the virtual wall W. In FIG. 7, the distance D1 between the calculation point C1 and the virtual wall W, the distance D2 between the calculation point C2 and the virtual wall W, and the distance D6 between the calculation point CC and the virtual wall W are shown.

When the controller 3 determines that the calculation points C1 to CC interfere with the virtual wall W by revolving, the controller 3 changes the posture of the work implement 15 so that the calculation points C1 to CC do not interfere with the virtual wall W. The controller 3 functions as the posture control section. The controller 3 operates the boom 21, the arm 22, and the bucket 23 so that calculation points C1-C6 are located on the side of the revolving center 12g with respect to the virtual wall W.

The controller 3 calculates the posture of the work implement 15 such that calculation points C1 to C6 do not interfere with the virtual wall W. The controller 3 transmits the data of the posture of the work implement 15, which does not interfere with the virtual wall W, to the detection section 4, and the detection section 4 calculates the amount of change in the boom angle θ2, the arm angle θ3, and the bucket angle θ4 to achieve a posture, which does not interfere with the virtual wall W, based on the dimension data stored in the storage device 4b. This data of the amount of change is sent from the detection section 4 to the controller 3, and the controller 3 sends drive signals to the EPC valves 65 to 72. In addition, the controller 3 may calculate the amount of change in the boom angle θ2, the arm angle θ3 and the bucket angle θ4. In this case, the controller 3 receives the first position data from the traveling unit posture sensor 94, the second position data from the work implement posture detection section 95, and the third position data from the revolving angle sensor 93. The storage device 3b of the controller 3 stores the dimensional data described above. The controller 3 can calculate the amount of change in the boom angle θ2, the arm angle θ3, and the bucket angle θ4 to achieve a posture that does not interfere with the virtual wall W from the dimensional data, the first position data, the second position data, and the third position data.

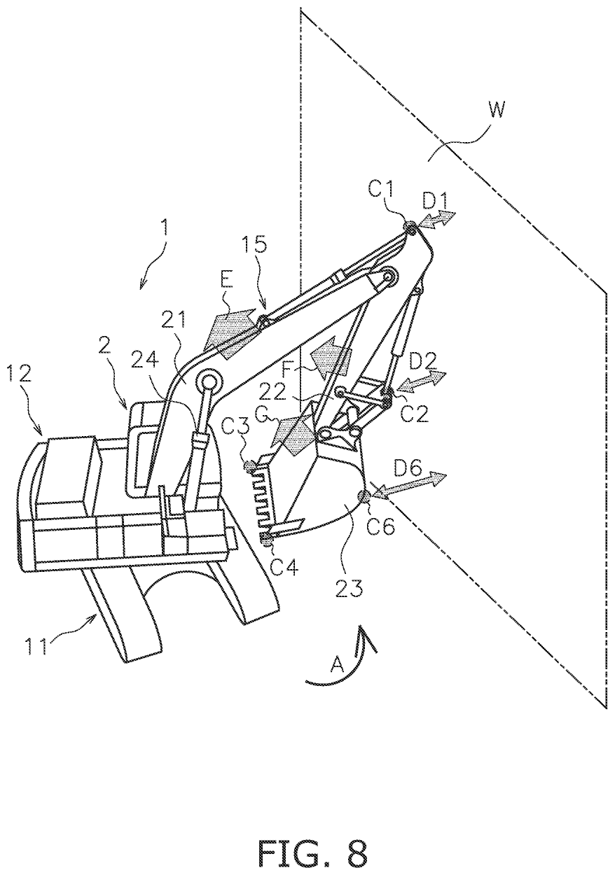

FIG. 8 is a perspective view illustrating the hydraulic excavator 1 in a state where the posture of the work implement 15 is changed so that the calculation points C1 to C6 do not interfere with the virtual wall W. FIG. 8 is a view illustrating a state in which the work implement 15 approaches the virtual wall W. The state of the work implement 15 shown in FIG. 8 is as follows: the boom 21 is swinged upward with respect to the revolving frame 13 from FIG. 7, the arm 22 is swinged inward so that the arm 22 approaches the boom 21, and the bucket 23 is swinged inward so that the tooth 234 moves (rolls in) inward. The controller 3 can change the posture of the work implement 15 by sending drive signals to the EPC valves 65 to 72. The controller 3 sends operating signals to the boom up EPC valve 65 and the boom down EPC valve 66 to adjust the opening degree of the boom up EPC valve 65 to be larger than that of the boom down EPC valve 66. Thereby, the valve 61 for the boom moves to the boom up position, the boom cylinder 24 extends, and the boom 21 swings upward (see arrow E). The controller 3 sends operating signals to the arm up EPC valve 67 and the arm down EPC valve 68 to adjust the opening degree of the arm down EPC valve 68 to be larger than that of the arm up EPC valve 67. Thereby, the valve 62 for the arm moves to the arm down position, the arm cylinder 25 extends, and the arm 22 swings inward (see arrow F). The controller 3 sends drive signals to the bucket up EPC valve 69 and the bucket down EPC valve 70 to adjust the opening degree of the bucket down EPC valve 70 to be larger than that of the bucket up EPC valve 69. Thereby, the valve 63 for the bucket moves to the bucket down position, the bucket cylinder 26 extends, and the bucket 23 swings toward the rolling-in direction (see arrow G). In FIG. 8, the distance D1 between the calculation point C1 and the virtual wall W, the distance D2 between the calculation point C2 and the virtual wall W, and the distance D6 between the calculation point C6 and the virtual wall W are shown. In addition, for example, the controller 3 may calculate positions in which the calculation points C1 to C6 do not interfere with the virtual wall W under the condition that the swing direction of the boom 21 with respect to the revolving frame 13 is limited to the upward direction, the swing direction of the arm 22 is limited to the inward direction such that the arm 22 approaches the boom 21, and the swing direction of the bucket 23 is limited to the inward direction such that the tooth 234 moves inward (rolls in).

Thus, the controller 3 automatically changes the posture of the work implement 15 so that the calculation points C1 to C6 do not interfere with the virtual wall W. As a result, the revolving operation can be executed continuously without stopping due to interference with the virtual wall W. In FIG. 6, when the work implement 15 approaches the virtual wall W by revolving, the posture of the work implement 15 is changed. In the state of the changed posture, the work implement 15 is revolved to a position facing the dump truck 102 without interfering with the virtual wall W (see the bucket 23, indicated by the two-dot chain line).

When the controller 3 receives an operation instruction from the operating device 81, the controller 3 determines whether or not the change in the posture of the work implement 15 can be completed before the calculation points C1 to C6 interfere with the virtual wall W when revolving at the revolving speed by the operation instruction. When the controller 3 determines that the change in the posture can be completed, the controller 3 sends drive signals to the EPC valves 65 to 72 to change the posture of the work implement 15 while revolving. When the controller 3 determines that the change in the posture cannot be completed, the controller 3 controls the left revolving EPC valve 71 and the right revolving EPC valve 72 to operate the valve 64 for the revolution and stops the revolving motor 27.

When the controller 3 determines that the change in the posture of the work implement 15 cannot be completed before the calculation points C1 to C6 interfere with the virtual wall W in the case of revolving at the revolving speed indicated by the operation instruction, the controller 3 may limit the revolving speed to a speed at which the change in the posture can be completed.

### (Operation)

Next, a control operation of the hydraulic excavator 1 of this embodiment will be explained.

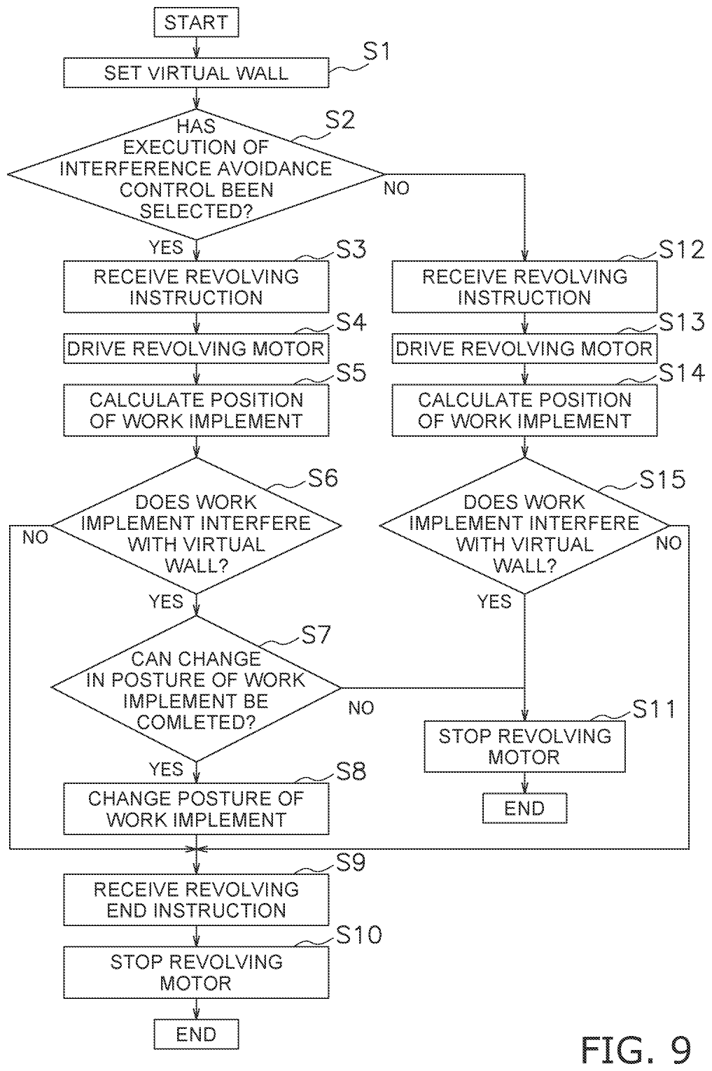

FIG. 9 is a flowchart illustrating the control operation of the hydraulic excavator 1.

First, in step S1, when the operator inputs the virtual wall W using the input device 82, the controller 3 sets the virtual wall W at a predetermined distance from the excavator main body 2.

Next, in step S2, the controller 3 determines whether or not the interference avoidance control is selected. The operator can select whether or not to execute the interference avoidance control using the input device 82. When the operator selects to execute the interference avoidance control, the control proceeds to step S3.

When the operator inputs the revolving instruction for the revolving unit 12 by operating the operating device 81, in step S3, the controller 3 receives the revolving instruction from the operating device 81.

Next, in step S4, the controller 3 drives the revolving motor 27 according to the revolving instruction to revolve the revolving unit 12. Specifically, when the revolving instruction is for revolving the revolving unit 12 to the left, the controller 3 sends operation signals to the left revolving EPC valve 71 and the right revolving EPC valve 72 to adjust the opening degree of the left revolving EPC valve 71 to be larger than that of the right revolving EPC valve 72. As a result, the valve 64 for the revolution moves to the left revolving position, hydraulic fluid is supplied, and the revolving motor 27 is driven to revolve the revolving unit 12 to the left.

Next, in step S5, the detection section 4 calculates the positions of the calculation points C1 to C6 of the work implement 15 based on the dimensional data stored in the storage device 4b, the pitch angle θ1, the boom angle θ2, the arm angle θ3, and the bucket angle θ4.

Next, in step S6, the controller 3 determines whether or not the work implement 15 interferes with the virtual wall W when the revolving unit 12 is revolved according to the revolving instruction. As described above, the controller 3 determines whether any of the calculation points C1 to C6 of the work implement 15 detected by the detection section 4 interfere with the virtual wall W.

When it is determined in step S6 that the work implement 15 interferes with the virtual wall W, the control proceeds to step S7.

In step S7, the controller 3 determines whether or not the change in the posture of work implement 15 can be completed before the work implement 15 interferes with the virtual wall W when the revolving unit 12 is revolved at the revolving speed of the revolving instruction from the operating device 81. For example, the controller 3 calculates the posture of the work implement 15 such that the calculation points C1 to C6 do not interfere with the virtual wall W, and transmits this posture data to the detection section 4. The detection section 4 calculates the amount of change in the boom angle θ2, the arm angle θ3, and the bucket angle θ4 to achieve a posture that does not interfere with the virtual wall W and transmits this data of change amount to the controller 3. The controller 3 determines whether or not the driving of the boom cylinder 24, the arm cylinder 25, and the bucket cylinder 26 corresponding to the amount of change in the boom angle θ2, the arm angle θ3, and the bucket angle θ4 that allows the work implement 15 to take the posture (described above) which does not interfere with the virtual wall W is completed before the work implement 15 interferes with the virtual wall W. In addition, the storage device 3b of the controller 3 may store the dimensional data described above, and the controller 3 may receive the first position data, the second position data, and the third position data to calculate the amount of change in the boom angle θ2, the amount of change in the arm angle θ3, and the amount of change in the bucket angle θ4. When it is determined in step S7 that the change in the posture of the work implement 15 can be completed before interference with the virtual wall W, the control proceeds to step S8.

In step S8, the controller 3 changes the posture of the work implement 15. For example, as shown in FIGS. 7 to 8, the controller 3 operates the boom 21 up, the arm 22 down, and the bucket 23 rolling-in.

In this way, the posture of the work implement 15 is changed while revolving, and the revolving of the revolving unit 12 is continued with a state in which the posture of the work implement 15 is changed.

When the operator inputs a revolving end instruction for the revolving unit 12 by operating the operating device 81, in step S9, the controller 3 receives the revolving end instruction from the operating device 81.

Next, in step S10, the controller 3 stops the revolving motor 27 and the control ends. The controller 3 sends operating signals to the left revolving EPC valve 71 and the right revolving EPC valve 72 so that the valve body of the valve 64 for the revolution is in the stop position. As a result, the supply of hydraulic fluid to the revolving motor 27 is stopped and the revolving motor 27 is stopped.

When it is determined in step S6 that the work implement 15 does not interfere with the virtual wall W, the revolving unit 12 is revolved with the current posture of the work implement 15. Then, when the controller 3 receives the revolving end instruction from the operating device 81 in step S9, the controller 3 stops the revolving motor 27 in step S10.

When it is determined in step S7 that the change in the posture of the work implement 15 cannot be completed before interference with the virtual wall W, the control proceeds to step S11. Then, in step S11, the controller 3 sends operation signals to the left revolving EPC valve 71 and the right revolving EPC valve 72 to stop the revolving motor 27, and the control is completed.

On the other hand, when the selection to not execute the interference avoidance control is made in step S2, the control proceeds to step S12.

When the controller 3 receives the revolving instruction from the operating device 81 in step S12, the controller 3 drives the revolving motor 27 to revolve the revolving unit 12 according to the revolving instruction in step S13.

Next, in step S14, the detection section 4 calculates the positions of the calculation points C1 to C6 of the work implement 15 based on the dimensional data stored in the storage device 4b, the pitch angle θ1, the boom angle θ2, the arm angle θ3, and the bucket angle θ4.

Next, in step S15, the controller 3 determines whether or not the calculation points C1 to C6 of the work implement 15 detected by the detection section 4 interfere with the virtual wall W when the revolving unit 12 is revolved according to the revolving instruction. When it is determined in step S15 that calculation points C1 to C6 interfere with the virtual wall W, the control proceeds to step S11. Then, in step S11, the controller 3 sends operation signals to the left revolving EPC valve 71 and the right revolving EPC valve 72 to stop the revolving motor 27.

On the other hand, when it is determined in step S15 that calculation points C1 to C6 do not interfere with the virtual wall W, the control proceeds to step S9. When the controller 3 receives the revolving end instruction from the operating device 81 in step S9, the controller 3 stops the revolving motor 27 in step S10, and the control ends.

### (Features, Etc.)

(1)

The hydraulic excavator 1 of the present embodiment includes the excavator main body 2, the detection section 4, and the controller 3. The excavator main body 2 includes the traveling unit 11 and the revolving unit 12. The revolving unit 12 includes the work implement 15 and is revolvable with respect to the traveling unit 11. The detection section 4 detects the position of the work implement 15. When the controller 3 determines that the work implement 15 interferes with the virtual wall W set at a predetermined position from the excavator main body 2, based on the position of the work implement 15, when the revolving unit 12 is revolved, the controller 3 changes the posture of the work implement 15 so as not to interfere with the virtual wall W.

By changing the posture of the work implement 15 so as not to interfere with the virtual wall W, the revolving operation of the revolving unit 12 can be continued. Therefore, it is possible to reduce work stoppages and facilitates smooth operation.

(2)

In the hydraulic excavator 1 of the present embodiment, the controller 3 changes the posture of the work implement 15 while revolving the revolving unit 12.

Thereby, the posture of the work implement can be changed so as not to interfere with the virtual wall W before the work implement reaches the virtual wall W while turning.

(3)

In the hydraulic excavator 1 of the present embodiment, when the controller 3 determines that the posture of the work implement 15 cannot be changed at the revolving speed of the revolving unit based on the input from the operating device 81 before the work implement 15 interferes with the virtual wall W, the controller 3 stops the revolving of the revolving unit 12.

Thereby, when it is determined that the change in the posture of the work implement 15 is not completed before reaching the virtual wall W, it is possible to stop the revolution.

(4)

In the hydraulic excavator 1 of the present embodiment, when the controller 3 determines that the posture of the work implement 15 cannot be changed at the revolving speed of the revolving unit based on the input from the operating device 81 before the work implement 15 interferes with the virtual wall W, the controller 3 limits the revolving speed of the revolving unit to a revolving speed at which the posture of the work implement 15 can be changed.

Thereby, it is possible to complete the change in the posture of the work implement 15 before reaching the virtual wall W by limiting the revolving speed.

(5)

In the hydraulic excavator 1 of the present embodiment, the excavator main body 2 further includes the input device 82. The input device 82 selects whether or not to execute the control to operate the work implement 15 not so as to interfere with the virtual wall W. When the controller 3 determines that the work implement 15 interfere with the virtual wall W when the revolving unit 12 is revolved by the input from the operating device 81 in a state in which non-executing the control is selected using the input device 82, the controller 3 stops the revolution of the revolving unit 12.

Thereby, the operator can select whether or not to execute the control of operating the work implement 15 so as not to interfere with the virtual wall W.

(6)

In the hydraulic excavator 1 of the present embodiment, the revolving unit 12 further includes the revolving frame 13 to which the work implement 15 is attached. The work implement 15 includes the boom 21, the arm 22, the bucket 23, the boom cylinder 24, the arm cylinder 25, and the bucket cylinder 26. The boom 21 is swingably attached to the revolving frame 13. The arm 22 is swingably attached to the boom 21. The bucket 23 is swingably attached to the arm 22. The boom cylinder 24 swings the boom 21. The arm cylinder 25 swings the arm 22. The bucket cylinder 26 swings the bucket 23. The controller 3 changes the posture of the work implement 15 by adjusting the hydraulic fluid supplied to the boom cylinder 24, the arm cylinder 25, and the bucket cylinder 26.

Thereby, it is possible to change the posture of the work implement 15 so as not to interfere with the virtual wall W.

(7)

In the hydraulic excavator 1 of the present embodiment, the bucket 23 includes the bottom part 231 which has a curved shape, the tooth 234 disposed at the tip of the bottom part 231, and a pair of side walls 233 disposed at both ends of the bottom part 231 in the width direction. The detection section 4 detects the calculation point C1, which is the tip position of the arm cylinder 25, the calculation point C2, which is the tip position of the bucket cylinder 26, the calculation points C3 and C4, which are the positions of both ends of the tooth 234 in the width direction, and the calculation points C5 and C6, which are the positions of both ends in the width direction of the portion of the bottom part 231 (an example of a predetermined portion of the bottom part) where the distance from the bucket excavation surface S is the largest. The controller 3 determines the interference of work implement 15 with the virtual wall W by whether or not the calculation points C1 to CC interfere with the virtual wall W due to the revolution of the revolving unit 12.

In this way, it is possible to detect the positions of a predetermined plurality of calculation points C1 to C6, and determine whether or not the work implement 15 interferes with the virtual wall W by the positional relationship between each of the detected plurality of calculation points C1 to C6 and the virtual wall W. Therefore, it is not necessary to calculate all positions of the work implement 15 to determine interference with the virtual wall W, and the calculation process can be simplified.

(8)

In the hydraulic excavator 1 of the present embodiment, the controller 3 changes the posture of the work implement 15 so that the detected multiple calculation points C1 to C6 do not interfere with the virtual wall W.

Thereby, it is possible to change the posture of the work implement 15 by a simple arithmetic process.

(9)

The method of controlling the hydraulic excavator 1 according to the present embodiment is a method of controlling the hydraulic excavator 1 which includes the traveling unit 11 and the revolving unit 12 including the work implement 15 and being revolvable with respect to the traveling unit 11. The method includes step S5 (an example of a position detection step), step SC (an example of a determination step), step S8 (an example of an interference avoidance step). In step S5, the position of the work implement 15 is detected. In step SC, it is determined whether or not the work implement 15 interferes with the virtual wall W set at a predetermined position from the hydraulic excavator 1 based on the position detected in step S5 when the revolving unit 12 is revolved. In step S8, when it is determined that the work implement 15 interferes with the virtual wall W, the posture of the work implement 15 is changed so as not to interfere with the virtual wall W.

### Other Embodiments

Although one embodiment of the present invention has been described above, the present invention is not limited to the above embodiment, and various changes can be made without departing from the gist of the invention.

### (A)

In the embodiment described above, the posture of the work implement 15 is changed while revolving the revolving unit 12 so as not to interfere with the virtual wall W, but the revolving unit 12 may be started after changing the posture of the work implement 15.

In addition, when it is determined that the posture of the work implement 15 cannot be changed before the work implement 15 interferes with the virtual wall W at the revolving speed by the operation instruction, the controller 3 may start the revolving unit 12 after changing the posture of the work implement 15.

### (B)

In the embodiment described above, the positions of the calculation points C1 to C6 of the work implement 15 are calculated to determine whether the work implement 15 interferes with the virtual wall W by revolving, but the calculation positions are not limited to the calculation points C1 to C6, the calculation points may be 7 points or more or 5 points or less. Although the amount of calculation increases compared to the above embodiment, the outermost position may be calculated by determining the position of the entire work implement 15 based on the dimensional data stored in the storage device 3b of the work implement 15, the pitch angle θ1, the boom angle θ2, the arm angle θ3, and the bucket angle θ4. The detection section 4 may detect the outermost position of the working implement 15, and the controller 3 may determines whether the work implement 15 interferes with the virtual wall W depending on whether the outermost position interferes with the virtual wall W by the revolving unit 12 revolving.

### (C)

In the embodiment described above, the virtual wall is disposed on the side of the hydraulic excavator 1. However, the virtual wall is not limited to the side, but may be located in front or behind the hydraulic excavator 1. Although the virtual wall is disposed on only one side of the hydraulic excavator 1, the virtual walls may be disposed on both sides. Furthermore, the hydraulic excavator 1 may be surrounded by the virtual walls.

### (D)

In the embodiment described above, the virtual wall W is set along the vertical direction, but it may be disposed on the upper side of the hydraulic excavator 1. In this case, the upward movement of the boom 21 to avoid interference with the virtual walls disposed along the vertical direction can be limited so as to avoid interference with the above virtual wall. Thereby for example, it is possible to revolve while avoiding contact with electric wires, etc.

### (E)

In the embodiment described above, the bucket 23 is attached to the tip of arm 22 as an example of an attachment, but it need not be limited to a bucket 23; a crusher or other device may be attached.

### (F)

In the embodiment described above, the boom angle sensor 95a is an IMU, but is not limited to this and may be a sensor that detects the stroke length of the boom cylinder 24. The arm angle sensor 95b is an IMU, but is not limited this and may be a sensor that detects the stroke length of the arm cylinder 25. The bucket angle sensor 95c is a sensor that detects the stroke of the bucket cylinder 26, but is not limited to this and may be an IMU. In short, the boom angle sensor 95a, the arm angle sensor 95b, and the bucket angle sensor 95c need only be sensors that can detect their respective angles.

### (G)

In FIG. 2 of the embodiment described above, the controller 3 and the detection section 4 are described as separate entities, but the functions of the detection section 4 may be realized within the controller 3. Specifically the controller 3 may receive signals from the traveling unit posture sensor 94, the boom angle sensor 95a, the arm angle sensor 95b, and the bucket angle sensor 95c, and the controller 3 may detect the posture of the work implement 15 based on each sensor signal. In this case, the processor 4a and the storage device 4b of the detection section 4 may not be provided.

### (H)

In the embodiment described above, the revolving motor 27 is a hydraulic motor, but is not limited to this and may be an electric motor.

According to the present disclosure, the work machine and the method of controlling the work machine have the effect that work can be performed smoothly even when the virtual wall is set, and is useful for hydraulic excavators and the like.

1. A work machine comprising:
a work machine main body including
a traveling unit and
a revolving unit including a work implement,
the revolving unit being configured to be revolvable with respect to the traveling unit;
a detection section configured to detect a position of the work implement; and
a posture control section configured to change a posture of the work implement so as not to interfere with a virtual wall set at a predetermined position from the work machine main body when determining that the work implement interferes with the virtual wall based on the position of the work implement when the revolving unit is revolved.

2. The work machine according to claim 1, wherein
the posture control section is configured to change the posture of the work implement while revolving the revolving unit.

3. The work machine according to claim 2, wherein
when determining that the posture of the work implement cannot be changed before the work implement interferes with the virtual wall at a revolving speed of the revolving unit based on an input from an operation instruction section, the posture control section is configured to stop a revolution of the revolving unit.

4. The work machine according to claim 2, wherein
when determining that the posture of the work implement cannot be changed before the work implement interferes with the virtual wall at a revolving speed of the revolving unit based on an input from the operation instruction section, the posture control section is configured to limit the revolving speed of the revolving unit to a revolving speed at which the posture of the work implement can be changed.

5. The work machine according to claim 1, further comprising:
a selection section configured to select whether or not to execute a control to operate the work implement so as not to interfere with the virtual wall,
in a state in which non-executing the control is selected by the selection section, when determining that the work implement interferes with the virtual wall when the revolving unit is revolved based on an input of an operation instruction section, the posture control section being configured to stop a revolution of the revolving unit.

6. The work machine according to claim 1, wherein
the detection section is configured to detect an outermost position of the work implement, and
the posture control section is configured to determine the interference of the work implement with the virtual wall by whether or not the outermost position interferes with the virtual wall when the revolving unit is revolved.

7. The work machine according to claim 1, wherein
the revolving unit further includes a frame part to which the work implement is attached,
the work implement includes
a boom swingably attached to the frame part,
an arm swingably attached to the boom,
an attachment swingably attached to the arm
a first cylinder configured to swing the boom,
a second cylinder configured to swing the arm, and
a third cylinder configured to swing the attachment, and
the posture control section is configured to change the posture of the work implement by adjusting hydraulic fluid supplied to the first cylinder, the second cylinder, and the third cylinder.

8. The work machine according to claim 7, wherein
the attachment is a bucket,
the bucket includes
a bottom part having a curved shape,
a tooth disposed at a tip of the bottom part, and
a pair of side walls disposed at both ends of the bottom part in a width direction,
the detection section is configured to detect a tip position of the second cylinder, a tip position of the third cylinder, both end positions in the width direction of the tooth, and both end positions in the width direction at a predetermined portion of the bottom part, and
the posture control section is configured to determine the interference of the work implement with the virtual wall by whether or not the detected plurality of the positions interfere with the virtual wall by revolving of the revolving unit.

9. The work machine according to claim 8, wherein
the posture control section is configured to change the posture of the work implement so that the detected plurality of the positions do not interfere with the virtual wall.

10. A method of controlling a work machine including a traveling unit and a revolving unit having a work implement, the revolving unit being configured to be revolvable with respect to the traveling unit, the method comprising:
a position detection step of detecting a position of the work implement;
a determination step of determining whether or not the work implement interferes with a virtual wall set at a predetermined position from the work machine based on a detection in the position detection step when the revolving unit is revolved; and
an interference avoidance step of changing a posture of the work implement so as not to interfere with the virtual wall when it is determined that the work implement interferes with the virtual wall.
